(19) United States
(12) Patent Application Publication
(10) Pub. No.: US 2007/0086478 A1
(43) Pub. Date: Apr. 19, 2007

(54) Apparatus for connecting of a plural of interface

(76) Inventor: Min Hyoung Lee, Gunpo (KR)

Correspondence Address: SHERR & NOURSE, PLLC, 620 HERNDON PARKWAY, SUITE 200, HERNDON, VA, 20170, US

(21) Appl. No.: 10/595,508

(22) PCT Filed: Aug. 25, 2004
(86) PCT No.: PCT/KR04/02135

§ 371 Date: Apr. 24, 2006

(30) Foreign Application Priority Data
Oct. 27, 2003 (KR) 10-2003-0075287
Mar. 16, 2004 (KR) 10-2003-0017739

(51) Int. Cl. H04L 12/66

(52) U.S. Cl. 370/463

(57) ABSTRACT

Disclosed is an apparatus for matching a plurality of interfaces. The matching apparatus includes a first matching unit provided in a first interface and a second interface, respectively, a second matching unit that is matched to the first matching unit, and a data transmit/receive unit for transmitting/receiving data by using one of the first and second interfaces that are connected by the matching of the first matching unit and the second matching unit. Therefore, a single port is used to selectively connect an optical interface and a copper interface. It is thus possible to reduce the number of a port in an Ethernet system, etc. and thus minimize the volume of the system.

### TECHNICAL FIELD

The present invention relates to a matching apparatus, and more particularly, to an apparatus for matching a plurality of interfaces, for network connection on an Ethernet system.

### BACKGROUND ART

Generally, a network can be described by basically referring to an OSI 7 layer. The OSI 7 layer is composed of a physical layer, a data link layer, a network layer, a transfer layer, a session layer, a presentation layer and an application layer.

Among the OSI 7 layer, only the physical layer being a first layer and the data link layer being a second layer, which correspond to FIG. 1 below, will be described.

The physical layer of the first layer is related to transmission of data from one computer to the other computer via a physical media. The physical layer includes defining how the cable is connected to the network adaptor card and what transmission scheme is used in transmitting the data through the cable.

The data link layer of the second layer is concerned with converting an electrical signal outputted from the network adaptor card to network frames. It transmits the frames from one computer to other computers. Furthermore, the data link layer is divided into two sub-layers. The upper layer of the two sub-layers is LLC (Logical Link Control). The LLC serves to manage data link communications and defines SAP (Service Access Point). The lower layer of the two sub-layers is MAC (Media Access Control) and performs direct communications with the network adaptor card of the physical layer being the first layer.

In order for the network card and the cable to be connected in the physical layer of the first layer, a matching apparatus is required. The matching apparatus includes a port and interface (an optical module, a RJ-45 connector, etc.) inserted into the port. In the above, the port is used as a female matching device and interface is used as a male matching device, interface being the male matching device is inserted into the port being the female matching device, thereby accomplishing matching.

For convenience of explanation, the optical module connected to an optical cable will be described as an optical interface and the RJ-45 connector connected to a copper wire will be described as a copper interface.

As time goes, an Ethernet-based Internet network increasingly has a high speed and a large capacity. Accordingly, the capacity and number of a port being the female matching device of the system matching apparatus are also increased and interface connected to each port becomes also diversified. If it is assumed that one matching device processes traffic of a 10 Gigabit capacity in the Ethernet system, ten or more Gigabit Ethernet ports are required. The Gigabit Ethernet can support both the optical cable and the copper wire according to the rules of IEEE802.3z (100BASE-X) and IEEE802.3ab (1000BASE-T). At this time, the Ethernet has additional ports each of which can accommodate the optical module (IEEE802.3z) and the RJ-45 (IEEE802.3ab) connector according to the standard.

Such an example will be described below with reference to FIG. 1.

FIG. 1 is a block diagram illustrating the construction of an apparatus for matching the interface in the related art.

The matching apparatus shown in FIG. 1 includes a data processing unit 101 being the second layer (Media Access Control, MAC) of the OSI layer and a data transmit/receive unit 102 being the first layer (PHY), both of which are connected by GMII. The data transmit/receive unit 102 is connected to an optical matching unit 106 by means of a SerDes (Serializer and Deserializer) and is connected to a copper matching unit 105 by means of MDI (Media Dependent Interface) In other words, the optical matching unit 106 is a port into which an optical interface 104 is inserted and the copper matching unit 105 is a port into which a copper interface 103 is inserted. As defined in the above, it is assumed that the optical interface 104 is an optical module to which the optical cable is connected and the copper interface 103 is the RJ-45 connector to which the copper wire is connected.

The matching apparatus shown in FIG. 1 includes the optical matching unit 106 and the copper matching unit 105 for connecting the optical interface 104 and the copper interface 103, respectively. The optical interface 104 is connected to the optical matching unit 106 and the copper interface 103 is connected to the copper matching unit 105.

In FIG. 1, if the optical interface 104 is inserted into the optical matching unit 106, the data transmit/receive unit 102 is connected to signal lines of the SerDes to exchange data with the optical interface 104.

Meanwhile, if the copper interface 103 is inserted into the copper matching unit 105, the data transmit/receive unit 102 is connected to signal lines of the MDI to exchange data with the copper interface 103. Such a connection status of these signal lines is shown in FIG. 2.

FIG. 2 shows a state where the signal lines are connected upon matching of the matching apparatus shown in FIG. 1.

Referring to FIG. 2, the data transmit/receive unit 102 is connected to the signal lines of the SerDes for an interface with the optical interface 104 and the signal lines of the MDI for an interface with the copper interface 103. If the optical interface 104 is inserted into the optical matching unit 106, however, only the signal lines of the SerDes are activated. On the contrary, if the copper interface 103 is inserted into the copper matching unit 105, only the signal lines of the MDI are activated. That is, the two kinds of the signal lines cannot be activated at the same time. Therefore, the data transmit/receive unit 102 transmits/receives data using only one of the two kinds of the signal lines, which are activated. Accordingly, in the Ethernet system, the optical interfacing and the copper interfacing are selectively performed and each matching unit into which each interface is inserted must be provided.

Therefore, a matching unit for matching with the optical interface and a matching unit for matching with the copper interface must be separately provided. Accordingly, although 20 or more ports are necessary outside a system such as Ethernet, the number of a port that is actually used is about 10. As such, the Ethernet system has a problem that the volume is increased since the system must have lots of unnecessary ports.

### DISCLOSURE OF INVENTION

Accordingly, the present invention has been made in view of the above problems, and it is an object of the present invention to provide an apparatus for matching a plurality of interfaces, wherein a single port supports an optical cable and a copper wire at the same time so that an optical interface representative of an optical module and a copper interface representative of a RJ-45 connector are attached/detached by the single port, whereby the optical interface and the copper interface are selectively interfaced.

To accomplish the above object, according to the present invention, there is provided a matching apparatus, including a first matching unit provided in a first interface and a second interface, respectively, a second matching unit that is matched to the first matching unit, and a data transmit/receive unit for transmitting/receiving data by using one of the first and second interfaces that are connected by the matching of the first matching unit and the second matching unit.

### BRIEF DESCRIPTION OF DRAWINGS

The above and other objects, features and advantages of the present invention will be apparent from the following detailed description of the preferred embodiments of the invention in conjunction with the accompanying drawings, in which:

FIG. 1 is a block diagram illustrating the construction of an apparatus for matching interface in the related art;

FIG. 2 shows a state where signal lines are connected upon matching of the matching apparatus shown in FIG. 1;

FIG. 3a is a block diagram in which an optical interface is matched to an apparatus for matching a plurality of interfaces according to an embodiment of the present invention;

FIG. 3b is a block diagram in which a copper interface is matched to an apparatus for matching a plurality of interfaces according to an embodiment of the present invention;

FIG. 4 shows a state where signal lines between a second matching unit and the a transmit/receive unit are connected upon matching of the matching apparatus shown in FIG. 3;

FIG. 5a to FIG. 5c show an external shape in which the optical interface and the first matching unit are coupled according to the present invention; and

FIG. 6a to FIG. 6c show an external shape in which the copper interface and the first matching unit are coupled according to the present invention.

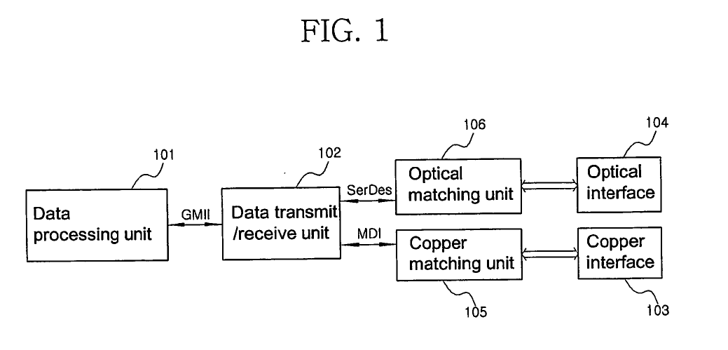

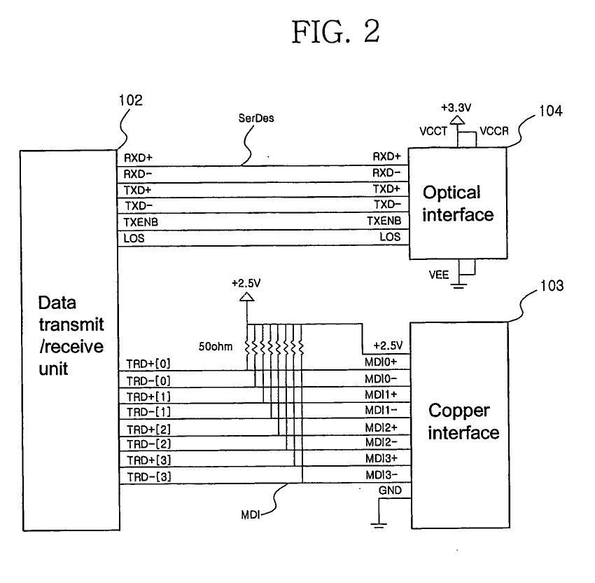

### BEST MODE FOR CARRYING OUT THE INVENTION

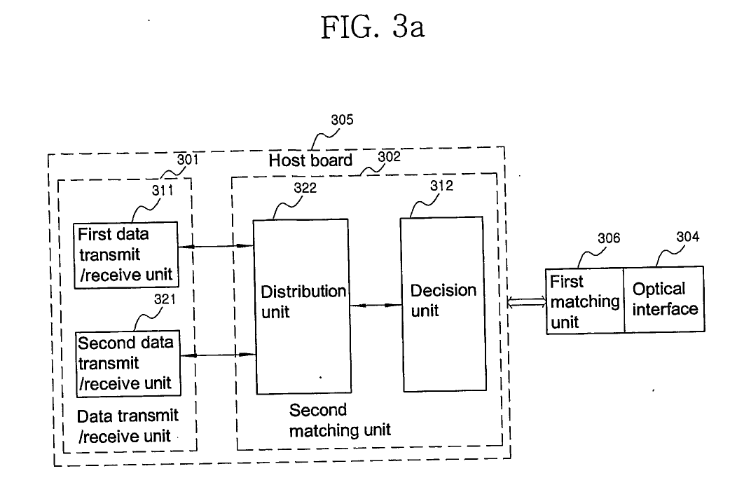

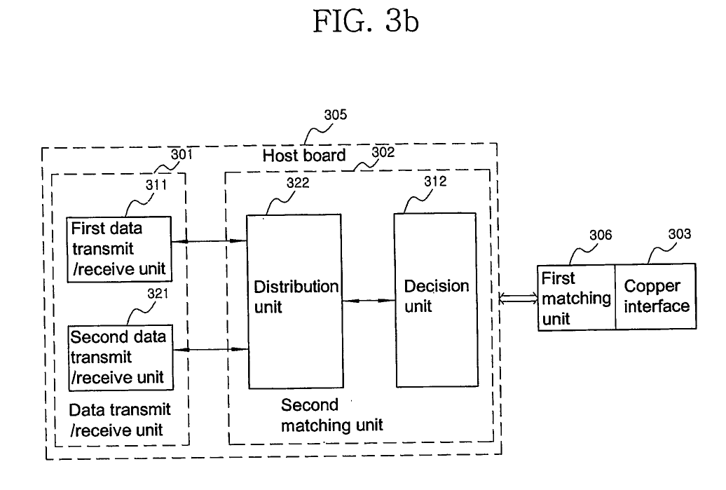

The present invention will now be described in detail in connection with preferred embodiments with reference to FIG. 3 to FIG. 6.

FIG. 3a is a block diagram in which an optical interface is matched to an apparatus for matching a plurality of interfaces according to an embodiment of the present invention.

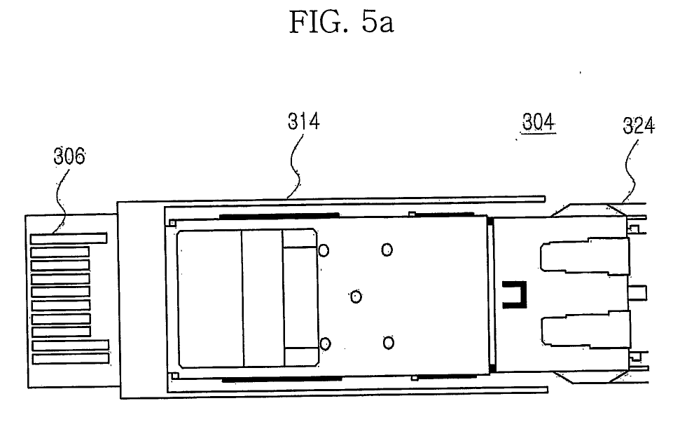

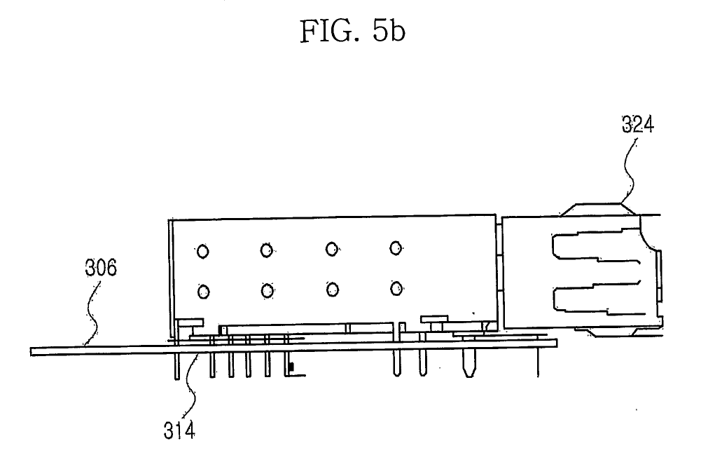

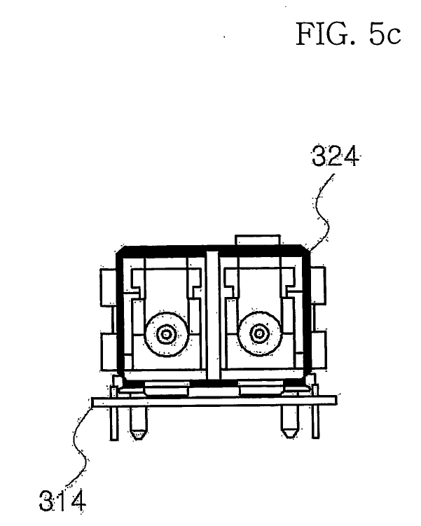

Referring to FIG. 3a, an optical interface 304 includes an optical module, and a first matching unit 306 being a circuit pattern, which is formed on a board. Such an optical interface 304 will be described below with reference to FIG. 5.

The first matching unit 306 serves to perform an interfacing function for connecting the optical interface 304 to signal lines of a host board 305 when the optical interface 304 is matched to the host board.

In the above, the first matching unit 306 is connected to a second matching unit 302 on the host board 305 and the second matching unit 302 is connected to a data transmit/receive unit 301. The second matching unit 302 is used as a port into which the optical interface 304 is inserted and is a female matching device. Further, the first matching unit 306 is a male matching device inserted into the second matching unit 302 and serves to connect the optical interface 304.

A data transmit/receive unit 301 includes a first data transmit/receive unit 311 for transmitting/receiving data for an optical interfacing and a second data transmit/receive unit 321 for transmitting/receiving data for a copper interfacing. Furthermore, the apparatus shown in FIG. 3a includes the second matching unit 302 for matching the optical interface 304 and the host board so that they are connected in order to exchange data with such a data transmit/receive unit 301. The second matching unit 302 is connected to the first matching unit 306 of the optical interface 304 so that it is matched with the first matching unit 306. The second matching unit 302 includes a decision unit 312 for determining whether a matched interface is the optical interface or the copper interface, and a distribution unit 322 for distributing signal lines for the optical interfacing or the copper interfacing depending on the determination result.

In FIG. 3a, the first matching unit 306 of the optical interface 304 and the second matching unit 302 of the host board 305 are matched in order to perform the optical interfacing through the connection of the optical interface 304 and the host board 305. That is, the optical interface 304 is inserted into the port disposed on the host board 305. Then, the decision unit 312 of the second matching unit 302 determines that the connected interface is the optical interface 304 and then outputs the determination result. The distribution unit 322 receives the determination result from the decision unit 312 and is thus connected to a first data transmit/receive unit 311 for the optical interfacing. Accordingly, a user can perform the optical interfacing using the host board 305 to which the optical interface 304 is connected. If it is desired to use the copper interfacing while performing such an optical interfacing, the user separates the optical interface 304 from the second matching unit 302 and inserts a copper interface 303 into the second matching unit 302. This will be described with reference to FIG. 3b.

FIG. 3b is a block diagram illustrating a state where the copper interface is matched to an apparatus for matching a plurality of interfaces according to an embodiment of the present invention.

Referring to FIG. 3b, in a host board 305, components having the same reference numerals have the same construction and operation described with reference to FIG. 3a.

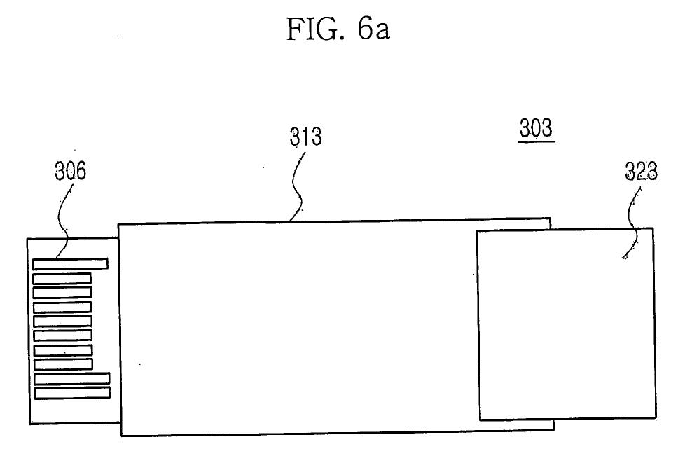

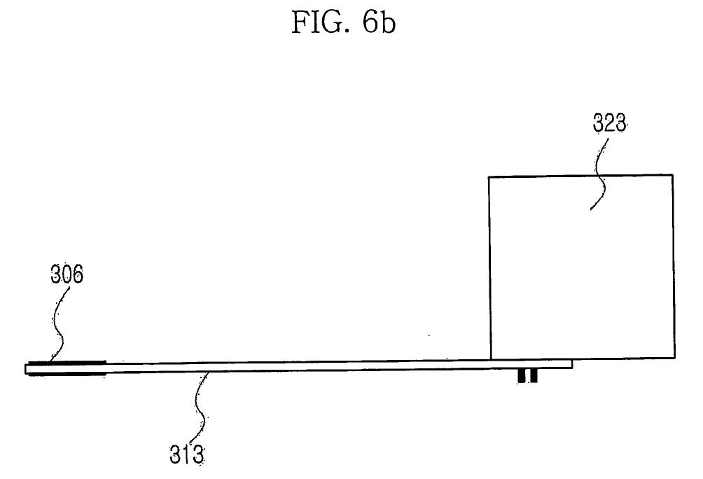

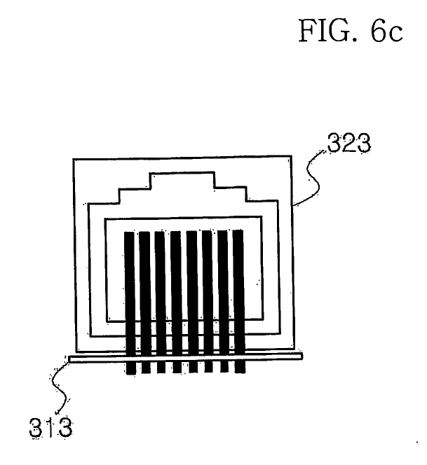

Therefore, a second matching unit 302 in FIG. 3b can also selectively match the optical interface 304 and the copper interface 303. The copper interface 303 also includes a RJ-45 connector, and a first matching unit 306 being a circuit pattern, which is formed on its board. Such a copper interface 303 will be below described with reference to FIG. 6.

In the above, the first matching unit 306 matches two interfaces of the optical interface 304 and the copper interface 303 to the second matching unit 302. For example, the first matching unit 306 may be implemented to be used in the two interfaces wherein five of 10 pins have circuit patterns for the optical interface 304 and the remaining 5 pins have circuit patterns for the copper interface 303. The circuit pattern of the second matching unit 302 matched to such the first matching unit 306 is implemented correspondingly. In other words, if the first matching unit 306 and the pins of the circuit patterns are implemented correspondingly in the second matching unit 302, a decision unit 312 determines what the interface is along circuit lines connected according to the circuit pattern, so that two interfaces can be selectively used. Also, as another example, in case of the copper interface 303 to which one of the circuit patterns of the first matching unit 306 is added, the copper interface 303 is implemented to output a voltage of a Low level. In case of the optical interface 304, the optical interface 304 is implemented to output a voltage of a High level. Accordingly, the decision unit 312 determines what the interface is based on the level of the voltage if the first matching unit 306 is matched.

In FIG. 3b, in order to perform a copper interfacing through the connection of the copper interface 303 and the host board 305, the first matching unit 306 of the copper interface 303 and the second matching unit 302 of the host board 305 are matched. In other words, the copper interface 303 is inserted into a port provided on the host board 305. Then, the decision unit 312 of the second matching unit 302 determines that the connected interface is the copper interface 303 and outputs the determination result. A distribution unit 322 receives the determination result from the decision unit 312 and is thus connected to the second data transmit/receive unit 321 for the copper interfacing. Accordingly, a user can perform the copper interfacing using the host board 305 to which the copper interface 303 is connected.

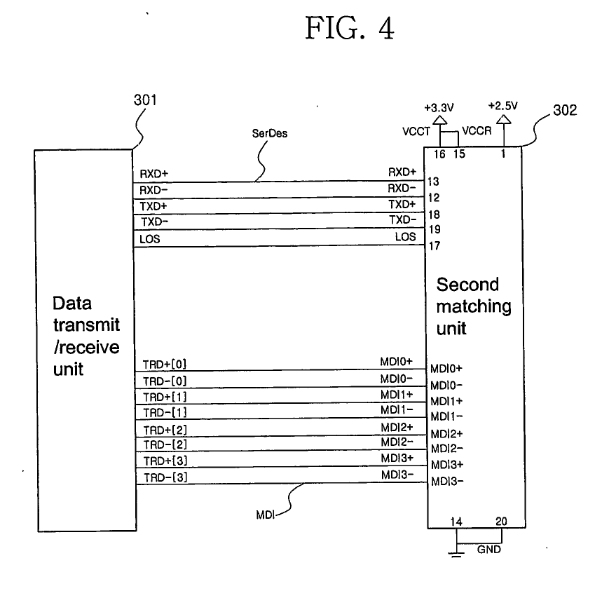

FIG. 4 shows a state where signal lines between the second matching unit and the transmit/receive unit are connected upon matching of the matching apparatus shown in FIG. 3.

Referring to FIG. 4, in the data transmit/receive unit 301, signal lines of a SerDes for an interface with the optical interface 304 and signal lines of a MDI for an interface with the copper interface 303 are connected to the second matching unit 302. However, if the optical interface 304 is inserted into the second matching unit 302 of the two kinds of the signal lines, only the signal lines of the SerDes are activated. On the contrary, if the copper interface 303 is inserted into the second matching unit 302, only the signal lines of the MDI are activated. Accordingly, the signal lines are activated depending on whether the interface matched to the second matching unit 302 is the optical interface or the copper interface, so that a corresponding interface can be performed. External shapes of the optical interface and the copper interface will be described with reference to FIG. 5 and FIG. 6, respectively.

FIG. 5a to FIG. 5c show an external shape in which the optical interface and the first matching unit are coupled according to the present invention.

FIG. 5a is a top view of the optical interface 304 and FIG. 5b is a side view of the optical interface 304. Circuit patterns of the first matching unit 306 are provided at a substrate 314 and the end of one side of the substrate. Further, an optical cable connection unit 324 for connecting the optical cable is provided at the end of the other side of the first matching unit 306.

FIG. 5c is a front view of the optical interface 304. The optical cable connection unit 324 is connected to the optical cable in order to perform optical transmission and optical reception.

FIG. 6a to FIG. 6c show an external shape in which a copper interface and the first matching unit are coupled according to the present invention.

FIG. 6a is a top view of the copper interface 303 and FIG. 6b is a side view of the copper interface 303. Circuit patterns of the first matching unit 306 are provided at a substrate 313 and at the end of one side of the substrate. Further, a copper wire connection unit 323 for connecting the copper wire is provided at the end of the other side of the first matching unit 306. FIG. 6c is a front view of the copper interface 303. The copper wire connection unit 323 is connected to the copper wire.

### INDUSTRIAL APPLICABILITY

As described above, according to the present invention, a single port is used to selectively connect an optical interface and a copper interface. It is therefore possible to minimize the volume of a system since the number of a port in an Ethernet system, etc. is reduced.

Furthermore, according to the present invention, it is possible to exclude the possibility that ports may be erroneously connected when an optical interface and a copper interface are connected using each port.

In addition, the present invention has a wide range of applications such as home networking apparatus and terminals, an apparatus for a Gigabit Ethernet interface in a PC, and other Gigabit Ethernet apparatus as well as a variety of Gigabit Ethernet-related apparatus existing on a network.

What is claimed is:

1. An apparatus for matching a plurality of interfaces, comprising:
a first matching unit provided in a first interface and a second interface, respectively;
a second matching unit that is matched to the first matching unit; and
a data transmit/receive unit for transmitting/receiving data by using one of the first and second interfaces that are connected by the matching of the first matching unit and the second matching unit.

2. The apparatus as claimed in claim 1, wherein the second matching unit comprises:
a decision unit for determining whether an interface matched to the first matching unit is the first interface or the second interface; and
a distribution unit for distributing signal lines so that a corresponding interface can be used depending on the determination result.

3. The apparatus as claimed in claim 2, wherein the decision unit determines whether the interface matched to the first matching unit is the first interface or the second interface depending on the level of a voltage.

4. The apparatus as claimed in claim 2, wherein the data transmit/receive unit comprises:
a first data transmit/receive unit for exchanging data with the first interface; and
a second data transmit/receive unit for exchanging data with the second interface.

5. The apparatus as claimed in claim 4, wherein the first interface is an optical interface.

6. The apparatus as claimed in claim 5, wherein the second interface is a copper interface.

7. The apparatus as claimed in claim 6, wherein the optical interface is connected to the first data transmit/receive unit by means of signal lines of a SerDes.

8. The apparatus as claimed in claim 6, wherein the copper interface is connected to the second data transmit/receive unit by means of signal lines of a MDI.
